(19) United States
(12) Patent Application Publication
(10) Pub. No.: US 2026/0063160 A1
(43) Pub. Date: Mar. 5, 2026

(54) SCREW WITH STEPPED HEAD

(71) Applicant: Spax International GmbH & Co. KG, Ennepetal (DE)

(72) Inventors: Frank Langewiesche, Sprockhövel (DE); Christian Steinmeister, Gevelsberg (DE)

(21) Appl. No.: 19/107,100

(22) PCT Filed: Jul. 13, 2023
(86) PCT No.: PCT/EP2023/069447

§ 371 Date: Feb. 27, 2025

(30) Foreign Application Priority Data
Aug. 29, 2022 (EP) 22192655.3

(51) Int. Cl. F16B 23/00

(52) U.S. Cl. CPC F16B 23/0007

(57) ABSTRACT

A screw having a head that is stepped is useable as a wood screw. The head may include multiple steps arranged one behind the other along a longitudinal axis of the screw. In a particular arrangement, the steps extend perpendicular to the longitudinal axis of the screw and may include a conical region formed between adjacent steps. The steps may be designed in such a way that a connection of outermost lateral points forms a lateral surface. The head may further include support pieces on the steps for support in a fitting.

### CROSS REFERENCE TO RELATED APPLICATION

This is a national stage application of PCT Application No. PCT/EP2023/069447, filed Jul. 13, 2023, which claims the benefit of European application Ser. No. EP22192655.3, filed on Aug. 29, 2022.

### BACKGROUND AND FIELD OF THE INVENTION

The invention described relates to a screw with a stepped head.

Screws with heads exist in the prior art, wherein the heads are conical in order to ensure a tight fit in the wood or in a fitting. They are suitable for universal use. However, conventional screws have the following disadvantages. The conical head drives the wood fibres apart when countersinking and the wood tends to split. In the edge region, splitting causes considerable problems with the screw connection.

Various manufacturers developed such countersunk screws further and equipped the heads with various shapes of ribs and pockets. The aim of the pockets and ribs is to mill up the wood fibres as the head is countersunk in order to reduce wood splitting. However, some of the wood fibres partially rip off in the process, or the wood fibres line up as splinters in the area around the screw head and hinder the fastening of the screw.

### SUMMARY OF THE INVENTION

An object of the present invention is to eradicate the disadvantages of the prior art and in particular to improve the screwing-in of screws.

This object is achieved with the subject of the independent claims. Advantageous further developments of the invention are specified in the subclaims. All combinations of at least two of the features specified in the description, claims and/or figures also fall within the scope of the invention. Values lying within the specified value ranges should also be disclosed as limit values and be claimable in any combination.

The invention relates to a screw with a head, wherein the head is stepped.

According to the invention, it is advantageously possible that the stepped design has the same effect as a punching tool when striking a wood surface such that wood fibres are cut through, in particular in the direction of the longitudinal axis of the screw. Advantageously, there is hardly any wedge effect when countersinking the screw such that unwanted splinters cannot occur or at least only to a minor extent. The undesirable milling effect therefore hardly occurs anymore.

In one preferred embodiment, it is provided that the head has several steps, wherein the steps are arranged one behind the other along a longitudinal axis of the screw, wherein the steps are in particular arranged directly one behind the other. This arrangement advantageously makes it possible for the advantageous punching action to occur several times in succession, and it is particularly preferably provided that the punching action can occur in direct succession.

In another preferred embodiment, it is provided that the steps extend perpendicular to the longitudinal axis of the screw, wherein in particular lower edges of the steps run perpendicular to the longitudinal axis. This advantageously makes it possible to achieve a particularly good punching action, in particular when the angle between the lower edges of the steps and the screw-in direction or longitudinal axis of the step is 90°.

In another preferred embodiment, it is provided that a conical region is located between adjacent steps. This advantageously makes it possible, compared to perpendicular steps, which are arranged directly one behind the other, to produce a gradual transition between successive steps such that the punching action is not jerky, but can occur with a smaller rise.

In another preferred embodiment, it is provided that the head is formed rotationally symmetrical to the longitudinal axis of the screw. As a result, the steps or the stepped design are also formed rotationally symmetrical to the longitudinal axis. This advantageously makes it possible for the punching action to occur uniformly on all sides in the lateral direction of the screw.

In another preferred embodiment, it is provided that the steps are arranged circumferentially around the longitudinal axis of the screw and in particular annularly. Similarly to the rotationally symmetrical design, it is also advantageously possible here for the punching action to be uniform in all lateral directions.

In another preferred embodiment, it can be provided that the steps are circular-cylindrical in shape and have in particular centrally located openings for a drive of a tool. This design advantageously makes it possible, on the one hand, to achieve a uniform punching action in the lateral direction and, on the other hand, to achieve direction transmission of the force of a tool into the desired punching action.

In one preferred embodiment, it is provided that the steps are designed in such a way that a connection of outermost lateral points forms a lateral surface M, M′, wherein the lateral surface M, M′ has an opening angle W of 80° to 100°, preferably 90°. This advantageously makes it possible to insert the screw according to the invention even in conventional fittings with opening angles of 80° to 100° such that advantageously no extra fittings have to be used.

In one preferred embodiment, it is provided that the head has support pieces on the steps for support in a fitting. The support pieces can advantageously make it possible to improve the support in the fitting as there is a larger surface for support.

The support pieces are preferably arranged symmetrically with respect to the longitudinal axis. This advantageously achieves a uniform distribution of the load in the fitting.

In another preferred embodiment, it is provided that the screw has at least two steps, and a plurality of support pieces are arranged on each step. This can be advantageous in that the screw can be placed better in the fitting.

In another preferred embodiment, it is provided that the support pieces respectively extend at a radial angle of 10 to 50°. This ensures optimum support in the fitting, wherein the undesired milling effect can be reduced at the same time.

In another preferred embodiment, it is provided that two support pieces are respectively arranged on different steps one behind the other in alignment along the longitudinal axis, preferably on directly successive steps. This advantageously ensures that the loads in the fitting can be evenly absorbed.

Further advantages, features and details of the invention are given in the following description of preferred exemplary embodiments and based on the drawings; these respectively show in a schematic view:

### BRIEF DESCRIPTION OF THE DRAWINGS

FIG. 1 shows a head of a screw according to a first embodiment according to the invention in a side view;

FIG. 2 shows the head of FIG. 1 in a perspective view;

FIG. 3 shows a head of a screw according to a second embodiment according to the invention in a side view;

FIG. 4 shows the head of FIG. 3 in a perspective view;

FIG. 5 shows the head from FIG. 1 in a conventional fitting;

FIG. 6 shows a head of a screw according to a third embodiment according to the invention;

FIG. 7 shows the head of FIG. 6 in a perspective view;

FIG. 8 shows the head of FIG. 6 in a view from below of the head;

FIG. 9 shows the head from FIG. 6 in a conventional fitting; and

FIG. 10 shows a head of a screw of a fourth embodiment according to the invention in a view from below of the head.

### DESCRIPTION OF THE PREFERRED EMBODIMENTS

In the figures, advantages and features of the invention are marked with reference numbers respectively identifying them according to embodiments of the invention, wherein components or features with the same or similar function are marked with identical reference numbers.

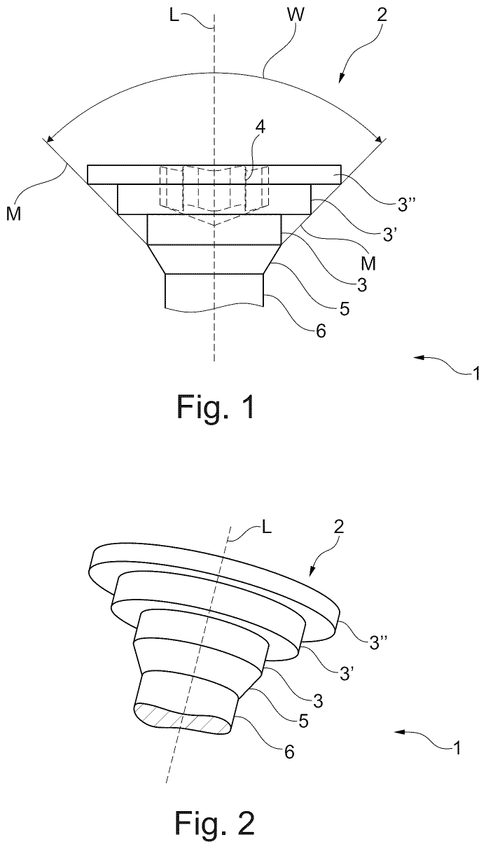

FIG. 1 schematically shows a head 2 of a screw 1 according to a first embodiment according to the invention in a side view. The screw 1 is not illustrated further. A person skilled in the art knows how screws, in particular wood screws, are designed. FIG. 2 shows the screw 1 in a schematic perspective view.

The head 2 is formed rotationally symmetrical to a longitudinal axis L of the screw 1. The screw 1 extends along the longitudinal axis L from the head 2 towards a front end, which is not shown.

According to the invention, the head 2 is stepped. In this exemplary embodiment, the head 2 has three steps 3, 3′, 3″.

FIG. 1 further shows with dashed lines that the head 2 has a receiving opening 4 for being driven by a tool, e.g. a bit. The steps 3, 3′, 3″ are circular-cylindrical in shape and have in particular centrally located openings for the drive of the tool.

The steps 3, 3′, 3″ extend perpendicular to the longitudinal axis L. Lower edges of the steps run perpendicular to the longitudinal axis L. The steps are arranged directly one behind the other as seen in the longitudinal axis L.

The screw 1 has a circular cylindrical region 6, on which a thread (not shown) is arranged. A widening conically shaped region 5 extends from this region 6. The first step 3 is arranged behind this conically shaped region 5, the second step 3′ is arranged behind the first step 3 and the third step 3″ is arranged behind that.

FIG. 1 further shows a lateral surface M of the head 2. This lateral surface M results from the connection of the outermost lateral points of the lower edges of the steps 3, 3′, 3″. In this exemplary embodiment, the opening angle W of the lateral surface M is 80°-100° such that the screw 2 according to the invention can be used in conventional fittings.

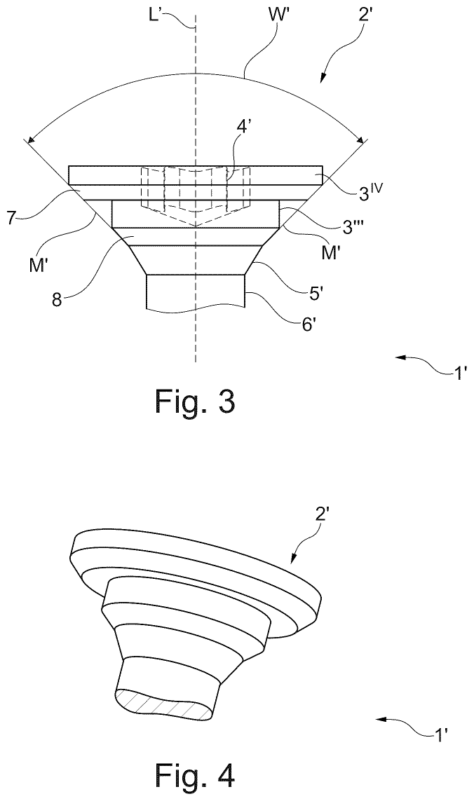

FIG. 3 schematically shows a head 2′ of a screw 1′ according to a second exemplary embodiment in a side view. The screw 1′ is not illustrated further. A person skilled in the art knows how screws, in particular wood screws, are designed. FIG. 4 shows the screw 1′ in a schematic perspective view.

The head 2′ is formed rotationally symmetrical to a longitudinal axis L′ of the screw 1′. The screw 1′ extends along the longitudinal axis L′ from the head 2′ towards a front end, which is not shown.

According to the invention, the head 2′ is stepped. In this exemplary embodiment, the head 2′ has only two steps 3′″ and 3^{IV}.

FIG. 3 further shows with dashed lines that the head 2′ has a receiving opening 4′ for being driven by a tool, e.g. a bit. The steps 3′″, 3^{IV} are circular-cylindrical in shape and have centrally located openings for the drive of the tool. The steps 3′″, 3^{IV} extend perpendicular to the longitudinal axis L′.

Unlike the first embodiment, this second embodiment only has two steps 3′″, 3^{IV}. A widening conical region 7 extends between the two steps 3′″, 3^{IV}, widening to the diameter of the step 3^{IV}.

As in the case of the first embodiment, the screw 1′ has a circular cylindrical region 6′, on which a thread (not shown) is arranged. A widening conically shaped region 5′ extends from this region 6′. A further conically shaped region 8 extends behind this conically shaped region 5′, widening towards the step 3′″.

A lateral surface M′ of the head 2′ is further shown in FIG. 3. This lateral surface M′ results from the connection of the outermost lateral points of the lower edges of the steps 3′″, 3^{IV} and the conical regions 7, 8.

In this exemplary embodiment, the opening angle W′ of the lateral surface M′ is 80°-100° such that the screw 1′ according to the invention can be used in conventional fittings.

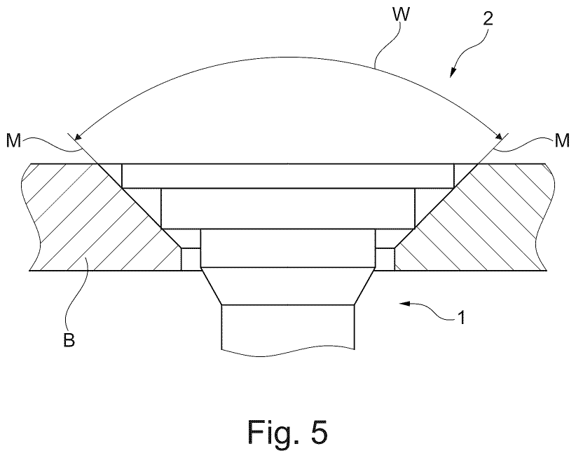

FIG. 5 schematically shows the screw 1 from FIGS. 1 and 2 in a conventional fitting B.

With regard to the design of the screw according to the invention, reference is made to the embodiments of FIGS. 1 and 2. This illustration shows that the screw 1 according to the invention can be easily used in conventional fittings B due to the opening angle W of 80°-100° of the lateral surface M. The lower edges of the screw 1 advantageously lie against the fitting such that no special production of fittings is necessary for the screw according to the invention. The same also applies mutatis mutandis to the embodiment from FIGS. 3 and 4, which could likewise be used with conventional fittings.

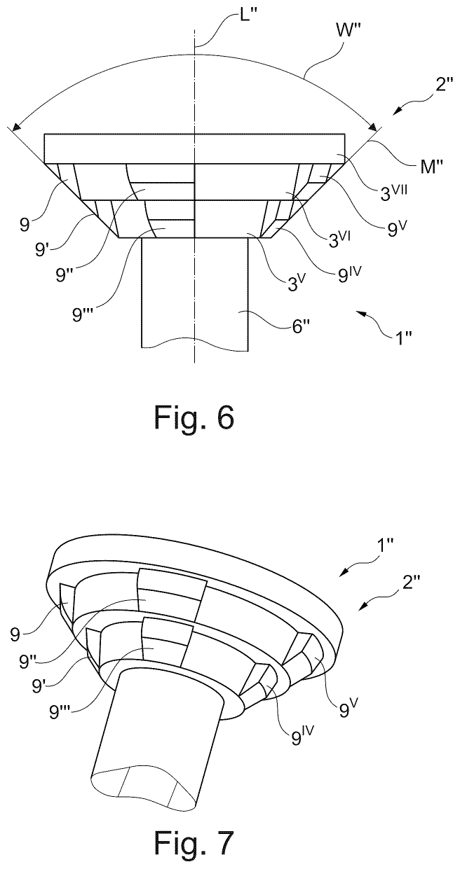

FIGS. 6 to 9 show a head 2″ of a screw 1″ according to a third embodiment according to the invention. Some aspects of the embodiments described above also apply to this embodiment.

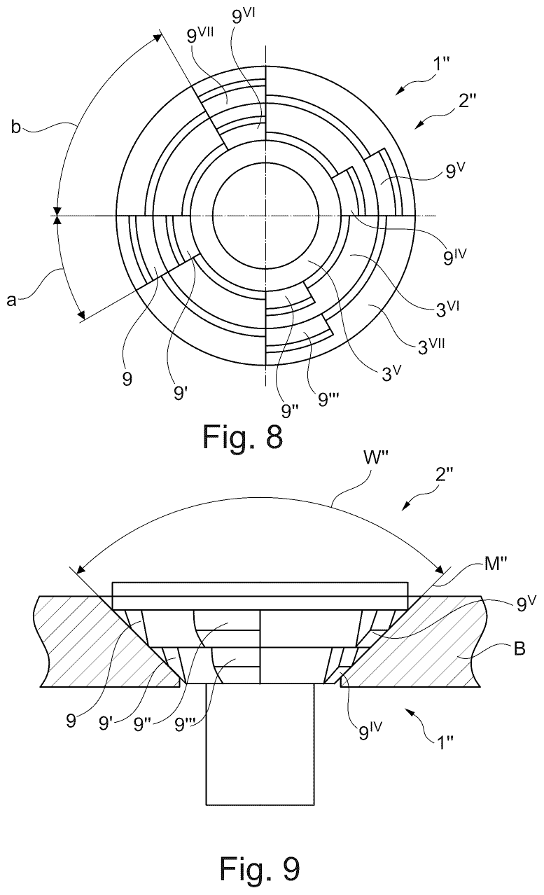

In contrast to the abovementioned embodiments, the screw 1″ has a head 2″, which has a total of eight support pieces 9, 9′, 9″, 9′″, 9^{IV}, 9^{V} and two support pieces 9^{IV}, 9^{IVV} shown in FIG. 8. All eight support pieces are shown in FIG. 8, which shows the head 2″ in a plan view from below.

The support pieces respectively have a support surface, which is inclined at an angle of 40° to 50° with respect to the longitudinal axis L′ such that the support piece rests with the support surface flush on a side edge of a fitting B (FIG. 9).

The support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV} are arranged symmetrically with respect to the longitudinal axis L″.

FIG. 8 shows that the support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV} respectively extend over an angle a about the longitudinal axis L″. An angle b extends between adjacent support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV}.

In this special embodiment, the angle a is around 10 to 30°; since the support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV} are arranged symmetrically, the angle b between adjacent support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV} is correspondingly between 60 and 80°.

Furthermore, four support pieces 9′, 9″, 9^{IV}, 9^{VI} are respectively symmetrically attached to the step S^{V}.

The other support pieces 9, 9′″, 9^{V}, 9^{VII} are arranged on the further step 3^{VI}.

The support pieces 9, 9′, 9″, 9′″, 9^{IV}, 9^{V}, 9^{VI}, 9^{VII}, 9^{VIII}, 9^{IX}, 9^{X}, 9^{XI}, 9^{XII}, 9^{XIII}, 9^{XIV}, 9^{XV} enable an improved fit of the screw 1″ or of the head 2″ in the fitting B, wherein the desired punching action can still take place in the foreground.

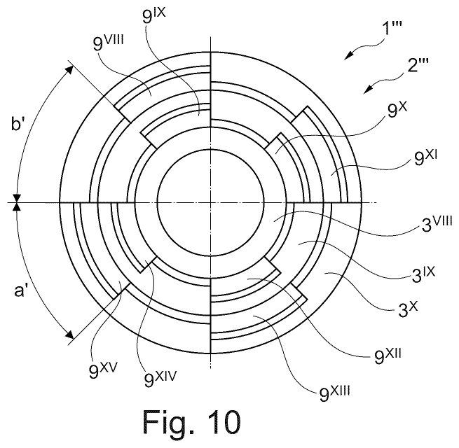

FIG. 10 schematically shows from below a view of a head 2′″ of a fourth embodiment of a screw 1′″ according to the invention. This fourth embodiment substantially has the features of the third embodiment. This fourth embodiment differs from the third embodiment in that the support pieces 9^{VIII}, 9^{IX}, 9^{X}, 9^{XI}, 9^{XII}, 9^{XIII}, 9^{XIV}, 9^{XV} extend at a greater angle a′ relative to the longitudinal axis in the radial direction than in the third embodiment with the angle a. In this embodiment, the angle a′ is around 45°.

As a result, the overall support surface of the support pieces 9^{VIII}, 9^{IX}, 9^{X}, 9^{XI}, 9^{XII}, 9^{XIII}, 9^{XIV}, 9^{XV} is greater than in the third embodiment such that an improved fit in the fitting B can be achieved, whereas the desired punching action is a little less.

Accordingly, the angle b′ between adjacent support pieces 9^{VIII}, 9^{IX}, 9^{X}, 9^{XI}, 9^{XII}, 9^{XIII}, 9^{XIV}, 9^{XV} is smaller than in the third embodiment and is approximately likewise 45°.

The above-described embodiments merely serve to illustrate the invention and in no way limit the subject of the invention or the idea of the invention.

1. A screw, said screw comprising a wood screw having a head, wherein the head is stepped.

2. The screw according to claim 1, wherein the head has a plurality of steps, wherein the steps are arranged one behind the other along a longitudinal axis of the screw, and wherein the steps are arranged directly one behind the other.

3. The screw according to claim 2, wherein the steps extend perpendicular to the longitudinal axis of the screw, and wherein lower edges of the steps run perpendicular to the longitudinal axis.

4. The screw according to claim 3, wherein a conical region is formed between adjacent steps.

5. The screw according to claim 4, wherein the head is formed rotationally symmetrical to the longitudinal axis of the screw, and wherein the steps are arranged annularly around the longitudinal axis of the screw.

6. The screw according to claim 5, wherein the steps are circular-cylindrical in shape and have centrally located openings for a drive of a tool.

7. The screw according to claim 6, wherein the steps are designed in such a way that a connection of outermost lateral points forms a lateral surface, and wherein the lateral surface has an opening angle of 80° to 100°.

8. The screw according to claim 1, wherein the head has support pieces on the steps for support in a fitting, and wherein the support pieces are arranged symmetrically with respect to the longitudinal axis.

9. The screw according to claim 8, wherein the screw has at least two steps, and a plurality of support pieces are arranged on each step.

10. The screw according to claim 9, wherein the support pieces respectively extend at a radial angle of 10 to 50°.

11. The screw according to claim 10, wherein two support pieces are respectively arranged on different steps one behind the other in alignment along the longitudinal axis on directly successive steps.

12. A screw, said screw comprising:
a head, wherein the head comprises a plurality of steps, and wherein the steps are arranged one behind the other along a longitudinal axis of the screw.

13. The screw according to claim 12, wherein the steps extend perpendicular to the longitudinal axis of the screw

14. The screw according to claim 13, and wherein lower edges of the steps run perpendicular to the longitudinal axis.

15. The screw according to claim 12, wherein a conical region is formed between adjacent steps.

16. The screw according to claim 12, wherein the head is formed rotationally symmetrical to a longitudinal axis of the screw, and wherein the steps are arranged circumferentially around the longitudinal axis of the screw.

17. The screw according to claim 12, wherein the steps are circular-cylindrical in shape, and wherein the head further comprises a centrally located opening for a drive of a tool.

18. The screw according to claim 12, wherein the steps are designed in such a way that a connection of outermost lateral points forms a lateral surface, and wherein the lateral surface has an opening angle of 80°to 100°.

19. The screw according to claim 12, wherein the head has support pieces on the steps for support in a fitting, and wherein the support pieces are arranged symmetrically with respect to the longitudinal axis.

20. The screw according to claim 19, wherein two support pieces are respectively arranged on different steps one behind the other in alignment along the longitudinal axis on directly successive steps.
